(19) United States
(12) Patent Application Publication
(10) Pub. No.: US 2002/0194602 A1
(43) Pub. Date: Dec. 19, 2002

(54) Expert model recommendation method and system

(75) Inventors: Srinivas V.R. Gutta, Buchanan, NY (US); David J. Schaffer, Wappingers Falls, NY (US); Kaushal Kurapati, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V

(21) Appl. No.: 09/875,403

(22) Filed: Jun. 6, 2001

(51) Int. Cl. G06F 3/00; H04N 5/445; G06F 13/00; G09G 5/00

(52) U.S. Cl. 725/45; 725/44; 345/744

(57) ABSTRACT

A program recommendation system employing a plurality of classifier modules is disclosed. In response to a reception of a record corresponding to a program, a classifier module correlated to a programming category indicated by the record as corresponding to the program will generate a recommendation of the program or each classifier module generates a recommendation of the program when the record fails to indicate a programming category corresponding to the program. When multiple recommendations are generated, a program record module of the system ranks the recommendations and utilizes the highest rank recommendation for the program.

### BACKGROUND OF THE INVENTION

1. Field of the Invention

The present invention relates to systems that employ an electronic program guide to assist a media user in managing a large number of media-content choices (e.g., television programming, chatrooms, on-demand video media files, audio, etc.). The present invention more specifically relates to systems having the “intelligence” to suggest choices to a user and to take actions based on the suggestions (e.g., record a program on behalf of the user).

2. Description of the Related Art

As the number of channels available to television viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, the ability to effectively identify desirable television programs using such printed guides has become impractical.

More recently, television program guides have become available in an electronic format, often referred to as electronic program guides (EPGs). Like printed television program guides, EPGs contain grids listing the available television programs by time, date, channel and title. An EPG, however, allows television viewers to sort or search the available television programs in accordance with personalized preferences. In addition, EPGs allow for on-screen presentation of the available television programs.

While EPGs allow viewers to identify several desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs, or sports programming. Thus, the viewer preferences can be applied to the EPG to obtain a set of recommended programs that may be of interest to a particular viewer.

The ultimate goal in the design of a television program recommendation program is to achieve the best possible classification of programs. This objective led to a development of a classifier (e.g., a decision tree classifier, a Bayesian classifier, etc.) or a combination of classifiers serving as a basis of a television program recommendation program. However, utilizing a single classifier or combination of classifiers as the basis fails to achieve an optimum performance of the system for each recommendation due to the inherent limitations of each classifier. The present invention addresses this problem.

### SUMMARY OF THE INVENTION

The present invention relates to an expert model recommendation method and system that overcomes the disadvantages associated with the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for generating recommendations of a plurality of programs. First, a record corresponding to a program is received. Second, a programming category corresponding to the program is identified. And, finally, a recommendation of the program is generated from a classifier module correlated with the programming category.

A second form of the present invention is a computer system for generating recommendations of a plurality of programs. The computer system comprises a program record module and a classifier module. In response to a reception of a record corresponding to a program, the program record module is operable to identify a programming category corresponding to the program. The classifier module is operable to generate a recommendation of the program when the classifier module is correlated with the programming category.

A third form of the present invention is a computer program product in a computer readable medium for generating recommendations of a plurality of programs. The computer program product comprises several computer readable codes. A computer readable code for receiving a record corresponding to a program. A computer readable code for identifying a programming category corresponding to the program. A computer readable code for generating a recommendation of the program from a classifier correlated with the program.

The foregoing forms and other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 is a schematic diagram of one embodiment in accordance with the present invention of an automated recommendation system;

FIG. 2 is a block diagram of one embodiment in accordance with the present invention of a controller of the FIG. 1 system;

FIG. 3A is a flow chart of a program recommendation routine in accordance with a first embodiment of the present invention; and

FIG. 3B is a flow chart of a program recommendation routine in accordance with a second embodiment of the present invention.

### DETAILED DESCRIPTION OF THE PRESENTLY PREFERRED EMBODIMENTS

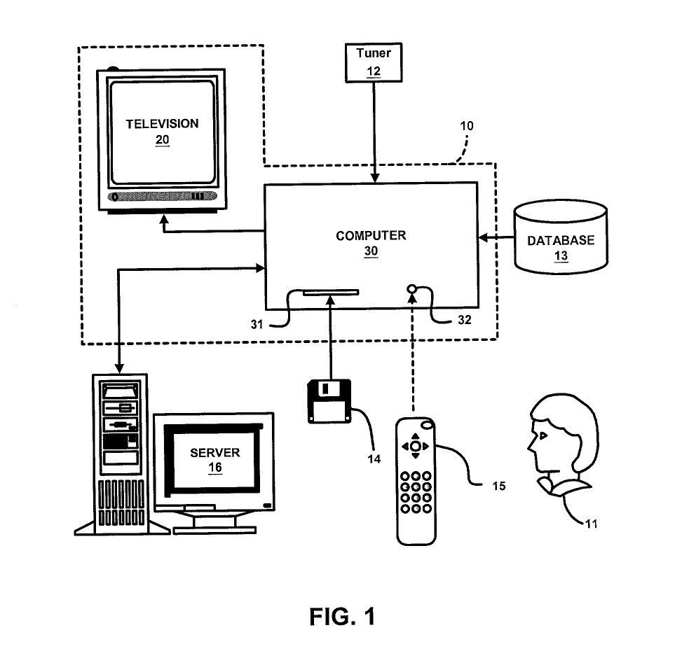

FIG. 1 illustrates an automated program recommendation system 10 for a user 11. System 10 comprises a display device in the form of a conventional television 20 as well a computer 30. Computer 30 can be housed within television 20 or set apart from television 20 as shown.

In the illustrated embodiment, computer 30 is equipped to receive program schedule data (e.g., an electronic program guide) from a server 16. Computer 30 can optionally receive feedback profile data, implicit profile data, and/or explicit profile data of other system 10 users from server 16. Computer 30 is further equipped to receive a video signal including program schedule data from a tuner 12 (e.g., a cable tuner or a satellite tuner). Computer 30 is also equipped with an infrared port 32 to allow user 11 to select a program to be viewed via a remote control 15. For example, user 11 can utilize remote control 15 to highlight a desired selection from an electronic program guide displayed on television 20. Computer 30 can have access to a database 13 from which computer 30 can receive updated program schedule data. The access can be accomplished by a telephone line connectable to an Internet service provider or some other suitable data connection. Computer 30 is further equipped with a disk drive 31 to upload program schedule data, profile data of user 11, and profile data of other system 10 users via a removable media such as a disk 14.

Computer 30 may be configured in any form for accepting structured inputs, processing the inputs in accordance with prescribed rules, and outputting the processing results to thereby control the display of television 20 as would occur to those having ordinary skill in the art. Computer 30 may therefore be comprised of digital circuitry, analog circuitry, or both. Also, computer 30 may therefore be programmable, a dedicated state machine, or a hybrid combination of programmable and dedicated hardware.

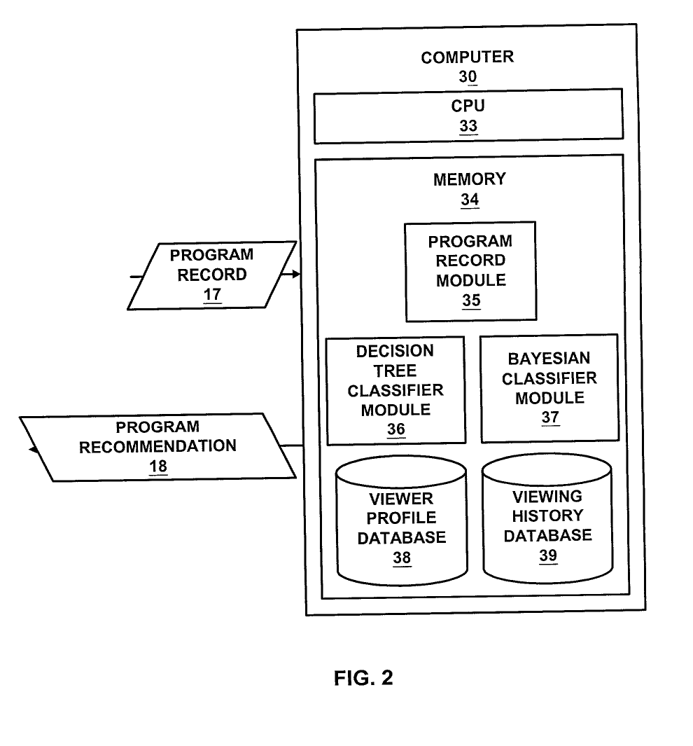

FIG. 2 illustrates one embodiment of computer 30. In the illustrated embodiment, computer 30 includes a central processing unit (CPU) 33 operatively coupled to a solid-state memory 34. CPU 33 can be from the Intel family of microprocessors, the Motorola family of microprocessors, or any other type of commercially available microprocessor. Memory 34 is a computer readable medium (e.g., a read-only memory, an erasable read-only memory, a random access memory, a compact disk, a floppy disk, a hard disk drive, and other known forms) that is electrically, magnetically, optically or chemically altered to contain computer readable code corresponding to a program record module 35, a decision tree classifier module 36, and a Bayesian classifier module 37. Additionally, memory 34 stores a viewing history database 38 of user 11 (FIG. 1), and a viewer profile database 39 of user 11 (FIG. 1). To implement the computer readable code within memory 34, computer 30 can additionally include any control clocks, interfaces, signal conditioners, filters, Analog-to-Digital (A/D) converters, Digital-to-Analog (D/A) converters, communication ports, or other types of operators as would occur to those having ordinary skill in the art.

In alternative embodiments of computer 30, program record module 35, decision tree classifier module 36, and/or Bayesian classifier module 37 can be partially or fully implemented with digital circuitry, analog circuitry, or both, such as, for example, an application specific integrated circuit (ASIC).

Decision tree classifier module 36 is one of many prior art programs for providing a recommendation based upon the well-established theory of concept learning, such as, for example, the decision tree classifier disclosed in U.S. patent application Ser. No. 09/466,406, filed Dec. 17, 1999, and entitled “Method And Apparatus For Recommending Television Programming Using Decision Trees”, hereby incorporated herein by reference.

Bayesian classifier module 37 is one of many prior art programs for providing a probabilistic calculation such as, for example, the Bayesian classifier disclosed in U.S. patent application Ser. No.______, filed ______, and entitled “Adaptive TV Program Recommender”, hereby incorporated herein by reference.

In other embodiments of computer 30, memory 33 can store additional classifiers module, such as, for example, one or more nearest neighbor classifier modules disclosed in U.S. patent application Ser. No. ______, filed concurrently herewith and entitled “Nearest Neighbor Recommendation Method and System”, hereby incorporated herein by reference. In yet other embodiments of computer 30, decision tree classifier module 36 and/or Bayesian classifier module 37 can be omitted from computer 30.

In response to a reception of a program record 17 from a program schedule data such as an EPG, CPU 33 controls an execution of program record module 35 and decision tree classifier module 36 or an execution of program record module 35 and Bayesian classifier module 37 whereby a program recommendation routine 40 or a program recommendation routine 50 is implemented.

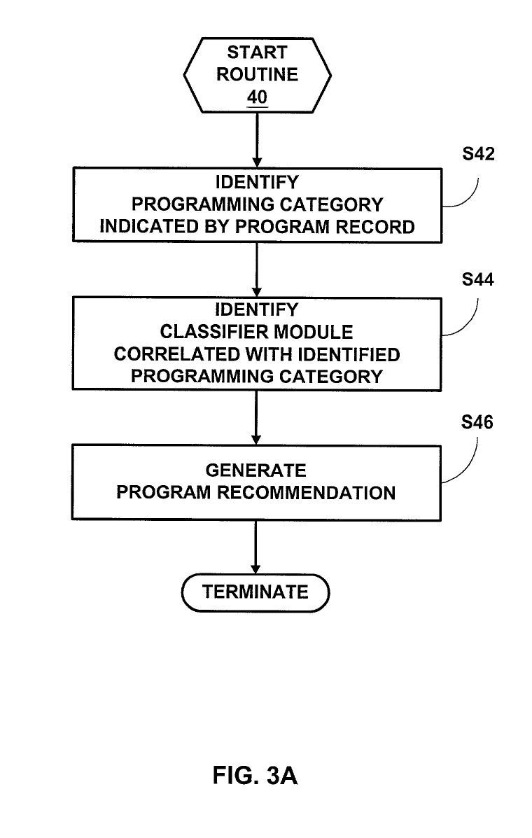

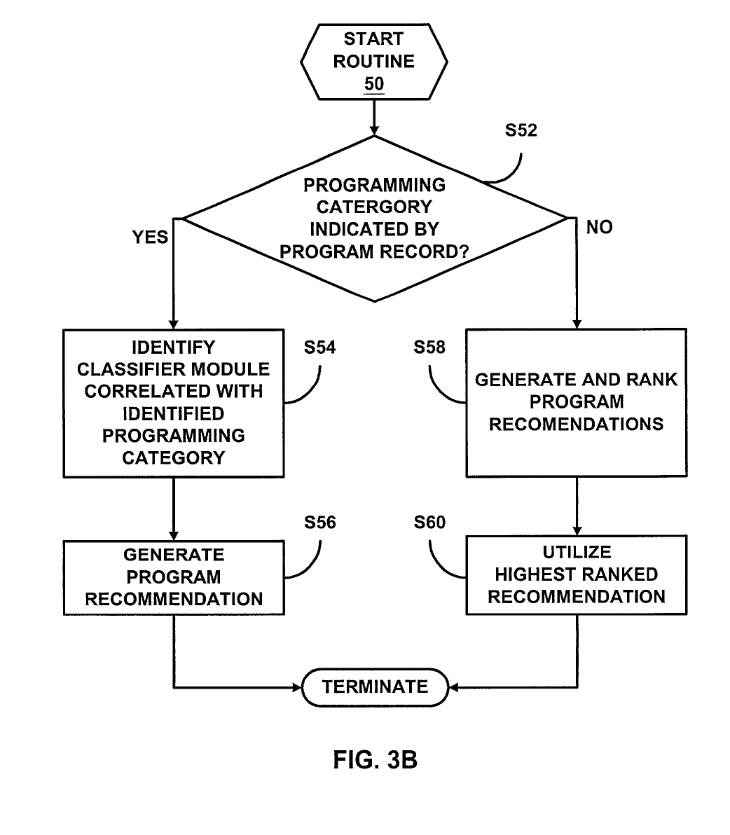

FIG. 3A illustrates routine 40. In the illustrated embodiment, during a stage S42 of routine 40, module 35 identifies a programming category indicated by program record 217. In one embodiment of stage S42, program record 17 includes a show tag as an indication of an allocation of the corresponding program to a programming category. The following TABLE 1 exemplary illustrates a listing of show tags and associated programming categories:

TABLE 1

| SHOW TAGS | PROGRAMMING CATEGORY |
|---|---|
| MVxxxxxxxxx | Movies |
| SHxxxxxxxxx | News/Talk Shows/Forums |
| Epxxxxxxxxx | Sitcoms |

In a second embodiment of stage S42, program record 17 includes a plurality of key fields as an indication of an allocation of the corresponding program to a programming category. The following TABLE 2 exemplary illustrates a listing of possible key fields within program record 17:

TABLE 2

| KEY FIELD | DESCRIPTION |
|---|---|
| $date | yyyymmdd |
| $air_time | hhmm from 0000-2359 |
| $station_sign | 4 characters |
| $title | 120 characters |
| $desc | 120 characters |
| $genre | 20 characters |
| $actors | 120 characters |
| $directors | 120 characters |
| $hosts | 120 characters |
| $producers | 120 characters |
| $writers | 120 characters |

The programming category is identifiable based upon the key fields within program record 17 and/or the data within the key fields. For example, program record 17 including key field $air_time indicating a two hour program at night and key field $genre indicating an action program as well as the inclusion of key fields $actors, $directors, $producers, and $writers is identified as a movie program. Also by example, program record 17 including key field $air_time indicating an hour program in the morning and key field $genre indicating a news program as well as the inclusion of key field $hosts is identified as a news/talk show/forum program.

During a stage S44 of routine 40, module 35 identifies a classifier module correlated (i.e., trained to provide a recommendation) with the programming category identified during stage S42. The following TABLE 3 exemplary illustrates a listing of programming categories and correlated classifier modules:

TABLE 3

| PROGRAMMING CATEGORY | CLASSIFIER |
|---|---|
| Movies | Bayesian Classifier Module 37 |
| News/Talk Shows/Forums | Decision Tree Classifier Module 36 |
| Sitcoms | Bayesian Classifier Module 37 |

During a stage S46 of routine 40, program record 17 is processed by the classifier module identified during stage S44 to thereby generate a program recommendation 18 of the program corresponding to program record 17. Program recommendation 18 is thereafter conventionally displayed on television 20.

Routine 40 is terminated upon completion of stage S46. Those having ordinary skill in the art will appreciate the benefit of routine 40 is an optimization of classifier resources.

FIG. 3B illustrates routine 50. In the illustrated embodiment, during a stage S52 of routine 50, module 35 ascertains whether program record 17 is indicating a programming category. In one embodiment of stage S52, module 35 ascertains whether program record 17 includes a show tag indicating the programming category as previously described herein in connection with stage S42 of routine 40. In another embodiment of stage S52, module 35 ascertains whether the program record 17 includes key fields indicating the programming category as previously described herein in connection with stage S42 of routine 40.

When module 35 determines program record 17 is indicating a programming category during stage S52, module 35 sequentially proceeds to a stage S54 and a stage S56 of routine 50. Stage S54 is synonymous with stage S44 of routine 40, and stage S56 is synonymous with stage S46 of routine 40. Routine 50 is terminated upon a completion of stage S56.

When module 35 determines program record 17 fails to indicate a programming category during stage S52, module 35 sequentially proceeds to a stage S58 and a stage S60 of routine 50. During stage S58, decision tree classifier module 36 and Bayesian classifier module 37 each generate a program recommendation of program record 17 and module 35 ranks the recommendations. During stage S60, module 35 utilizes the highest ranked recommendation as program recommendation 18. Routine 50 is terminated upon a completion of stage S60. Those having ordinary skill in the art will appreciate the benefit of routine 50 is an optimization of classifier resources.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. A method for generating recommendations of a plurality of programs, said method comprising:
receiving a first record corresponding to a first program;
identifying a first programming category corresponding to the first program; and
generating a first recommendation of the first program from a first classifier module correlated with the first programming category.

2. The method of claim 1, further comprising:
receiving a second record corresponding to a second program;
identifying the first programming category corresponding to the second program; and
generating a second recommendation of the second program from the first classifier module.

3. The method of claim 1, further comprising:
receiving a second record corresponding to a second program;
identifying a second programming category corresponding to the second program; and
generating a second recommendation of the second program from a second classifier module correlated with the second programming category.

4. A method for generating one or more recommendations of a program, said method comprising:
receiving a record corresponding to the program; and
generating a first recommendation of the program from a first classifier module correlated with a first programming category of a plurality of programming categories when the record indicates the program corresponds to the first programming category.

5. The method of claim 4, further comprising:
generating a second recommendation of the program from a second classifier module correlated with a second programming category of the plurality of programming categories when the record indicates the program corresponds to the second programming category.

6. The method of claim 5, further comprising:
concurrently generating the first recommendation from the first classifier module and the second recommendation from the second classifier module when the record fails to indicate an allocation of the program to one of the programming categories of the plurality of programming categories.

7. The method of claim 6, further comprising:
ranking the first recommendation and the second recommendation;
utilizing the first recommendation when the first recommendation has the highest rank; and
utilizing the second recommendation when the second recommendation has the highest rank.

8. A computer system for generating recommendations of a plurality of programs, said computer system comprising:
a program record module operable to identify a first programming category of a plurality of programming categories that corresponds to a first program in response to a reception of a first record corresponding to the first program; and
a first classifier module correlated to the first programming category, said first classifier module being operable to generate a first recommendation of the first program when said program record module identifies the first programming category as corresponding to the first program.

9. The computer system of claim 8,
wherein said program record module is further operable to identify the first programming category corresponding to a second program in response to a reception of a second record corresponding to the second program; and
wherein said first classifier module is further operable to generate a second recommendation of the second program when said program record module identifies the first programming category as corresponding to the second program.

10. The computer system of claim 8, further comprising:
a second classifier module correlated to a second programming category of the plurality of programming categories.

11. The computer system of claim 10,
wherein said program record module is further operable to identify the second programming category corresponding to a first program in response to a reception of the first record; and
wherein said second classifier module is operable to generate a second recommendation of the first program when said program record module identifies the second programming category as corresponding to the first program.

12. The computer system of claim 10,
wherein said program record module is further operable to identify the second programming category corresponding to a second program in response to a reception of the second record; and
wherein said second classifier module is operable to generate a second recommendation of the second program when said program record module identifies the second programming category as corresponding to the second program.

13. The computer system of claim 10,
wherein said first classifier module is further operable to generate the first recommendation of the first program when said program record module fails to identify any of the programming categories as corresponding to the first program; and
wherein said second classifier module is further operable to generate a second recommendation of the first program when said program record module fails to identify any of the programming categories as corresponding to the first program.

14. The computer system of claim 13,
wherein said program record module is further operable to rank the first recommendation and the second recommendation;
wherein said program record module is further operable to utilize the first recommendation when the first recommendation has the highest rank; and
wherein said program record module is further operable to utilize the second recommendation when the second recommendation has the highest rank.

15. A computer program product in a computer readable medium for generating recommendations of a plurality of programs, said computer program product comprising:
computer readable code for receiving a first record corresponding to a first program and a second record corresponding to a second program;
computer readable code for identifying a first programming category corresponding to the first program and identifying a second programming category corresponding to the second program; and
computer readable code for generating a first recommendation of the first program from a first classifier correlated to the first programming category and a second recommendation of the second program from a second classifier correlated to the second programming category.

16. A computer program product in a computer readable medium for generating recommendations of a plurality of programs, said computer program product comprising:
computer readable code for receiving a first record corresponding to a program;
computer readable code for generating a first recommendation of the program from a first classifier correlated to a first programming category of a plurality of programming categories upon a failure to identify any programming category of the plurality of programming categories as corresponding to the program; and
computer readable code for generating a second recommendation of the program from a second classifier correlated to a second programming category of a plurality of programming categories upon a failure to identify any programming category of the plurality of programming categories as corresponding to the program.

17. The computer program product of claim 16, further comprising:
computer readable code for ranking the first recommendation and the second recommendation;
computer readable code for utilizing the first recommendation when the first recommendation has the highest rank; and
computer readable code for utilizing the second recommendation when the second recommendation has the highest rank.

18. A computer system, comprising:
means for receiving a first record corresponding to a first program and a second record corresponding to a second program;
means for identifying a first programming category corresponding to the first program and identifying a second programming category corresponding to the second program; and
means for generating a first recommendation of the first program from a first classifier correlated to the first programming category and a second recommendation of the second program from a second classifier correlated to the second programming category.

19. A computer system, comprising:
means for receiving a first record corresponding to a program;
means for generating a first recommendation of the program from a first classifier correlated to a first programming category of a plurality of programming categories upon a failure to identify any programming category of the plurality of programming categories as corresponding to the program; and
means for generating a second recommendation of the program from a second classifier correlated to a second programming category of a plurality of programming categories upon a failure to identify any programming category of the plurality of programming categories as corresponding to the program.

20. The computer system of claim 19, further comprising:
means for ranking the first recommendation and the second recommendation;
means for utilizing the first recommendation when the first recommendation has the highest rank; and
means for utilizing the second recommendation when the second recommendation has the highest rank.
